(19) United States
(12) Patent Application Publication
(10) Pub. No.: US 2026/0206004 A1
(43) Pub. Date: Jul. 16, 2026

(54) USER EQUIPMENT PAGING MANAGEMENT USING NEIGHBOR LISTS

(71) Applicant: Kyocera Corporation, Kyoto (JP)

(72) Inventors: Amit KALHAN, San Diego, CA (US); Henry CHANG, San Diego, CA (US)

(21) Appl. No.: 19/135,526

(22) PCT Filed: Dec. 14, 2023
(86) PCT No.: PCT/US2023/083978

§ 371 Date: Jun. 4, 2025

Related U.S. Application Data
(60) Provisional application No. 63/434,396, filed on Dec. 21, 2022.
(60) Provisional application No. 63/434,821, filed on Dec. 22, 2022.

(51) Int. Cl. H04W 68/02; H04W 8/00; H04W 64/00; H04W 76/30; H04W 92/18

(52) U.S. Cl. CPC H04W 68/02; H04W 8/005; H04W 64/00; H04W 76/30; H04W 92/18

(57) ABSTRACT

After determining a paging message is required for a selected user equipment (UE) device, an apparatus evaluates neighbor list data of a neighbor list generated by a reporting user equipment (UE) device to determine the selected UE device is a neighbor device of the reporting UE device. Based on information from the neighbor list, the apparatus determines that the selected UE device is located within a geographical area within a paging area where the geographical area includes a subset of the base stations within the paging area. The apparatus invokes transmission of the paging message only from the base stations in the geographical area without transmission of the paging message from other base stations within the paging area.

### CLAIM OF PRIORITY

The present application claims priority to Provisional Application No. 63/434,396, entitled “D2D Neighbor List based Paging,” docket number TPRO 00380 US, filed Dec. 21, 2022, and to Provisional Application No. 63/434,821, entitled “D2D Neighbor List based Paging,” docket number TPRO 00381 US, filed Dec. 22, 2022, both assigned to the assignee hereof and hereby expressly incorporated by reference in their entirety.

### FIELD

This invention generally relates to wireless communications and more particularly to user equipment (UE) paging management using neighbor lists.

### BACKGROUND

Many wireless communication systems that employ several base stations that provide wireless service to user equipment (UE) devices enable sidelink communication between two or more UE devices where the UE devices can communicate directly with other UE devices. In addition, one or more UE devices can be used as relay devices between a source UE device and a destination UE device where the relay devices forward data received from the source UE device to the destination UE device. In many conventional communication systems, each UE device may be in one of at least two states. In systems operating in accordance with one or more 3GPP communication standards, for example, a UE device may be in an IDLE state, an INACTIVE state, or a CONNECTED state. When a UE device is in a state other than connected, the UE device is paged in order to initiate communication with the device. For example, when an incoming call is received for a UE device in IDLE, the core network sends a paging message for the UE device from cells provided by base stations (gNBs) in a Tracking Area (TA). Where a UE device is in INACTIVE when an incoming call arrives, a serving base station (serving gNB) initiates transmission of a paging message from all of the cells in a Radio Access Network (RAN) based Notification Area (RNA).

### SUMMARY

After determining a paging message is required for a selected user equipment (UE) device, an apparatus evaluates neighbor list data of a neighbor list generated by a reporting user equipment (UE) device to determine the selected UE device is a neighbor device of the reporting UE device. Based on information from the neighbor list, the apparatus determines that the selected UE device is located within a geographical area within a paging area where the geographical area includes a subset of the base stations within the paging area. The apparatus invokes transmission of the paging message only from the base stations in the geographical area without transmission of the paging message from other base stations within the paging area. In some examples where the selected UE device is in an IDLE state, the paging area is a Tracking Area (TA) and the apparatus is the core network (CN). In other examples where the selected UE device is in an INACTIVE state, the paging area is an RNA (RAN notification area) and the apparatus is the serving base station of the selected UE device.

### BRIEF DESCRIPTION OF THE DRAWINGS

FIG. 1 is a block diagram of a communication system where a network entity limits transmission of a paging message from less than all of the base stations in a paging area to a selected UE device to be paged based on neighbor list data.

FIG. 2 is a block diagram of an example of a base station suitable for use as any of the base stations.

FIG. 3 is a block diagram of an example of a UE device suitable for use as each of the UE devices.

FIG. 4A is a message flow diagram for an example where the selected UE device is in the RRC_INACTIVE state and the original serving base station identifies a subset of base stations for transmitting a paging message in the Radio Access Network (RAN) based Notification Area (RNA) where the subset may include a single base station.

FIG. 4B is a message flow diagram for an example where the selected UE device is in the RRC_INACTIVE state and the original serving base station determines that the selected UE device is within a cell of the original serving base station when the selected UE device is paged.

FIG. 5A is a message flow diagram for an example where the selected UE device is in the RRC_IDLE state and the original serving base station identifies a subset of base stations for transmitting a paging message in the Tracking Area (TA).

FIG. 5B is a message flow diagram for an example where the selected UE device is in the RRC_IDLE state and the core network determines the selected UE device is within a cell of the original serving base station when the selected UE device is paged.

FIG. 6 is a flow chart of an example of a method of managing UE device paging for UE devices in RRC_INACTIVE.

FIG. 7 is a flow chart of an example of a method of managing UE device paging for UE devices in RRC_IDLE.

FIG. 8 is a block diagram of an example of a neighbor list (NL) message.

FIG. 9 is a block diagram of the system for an example where a base station configures a UE device to transmit SL discovery signals to include selected information and parameters.

### DETAILED DESCRIPTION

As discussed above, UE devices in an RRC state other than RRC_CONNECTED are paged to reestablish the CONNECTED state when the transition is initiated by the core network (CN) or by the RAN. While in RRC_IDLE, a UE device monitors the paging channels for CN-initiated paging. While in RRC_INACTIVE, the UE device monitors paging channels for RAN-initiated paging. In conventional systems, the serving base station of a selected UE device in the INACTIVE state invokes transmission of a paging message from each base station in the RNA when an incoming call is being received for the selected UE device. For a selected UE device in the IDLE state in conventional systems, the core network (CN) invokes transmission of a paging message from each base station in the TA. Conventional systems, therefore, inefficiently require all the base stations in the paging area (TA or RNA) to transmit paging messages. Since these paging areas may include numerous base stations and since the selected UE device is typically reachable only by a single base station, one or more base stations transmit paging messages that are not receivable by the selected UE device. Accordingly, a technique that limits transmission of the paging message from one base station, or only a small number of base stations, is useful in increasing efficiency and minimizing communication traffic.

For the examples herein, neighbor list data from at least one neighbor list is evaluated and used to limit the number of base stations transmitting the paging message to a subset of the total base stations in the paging area. By at least determining a proximate location of the selected UE device, the paging procedure can be managed such hat the paging message is transmitted only from one base station (or a relatively small number of base stations) near the selected UE device location. For example, the paging message can be transmitted from the base station identified as having a cell coverage area that includes the location of the selected UE device that is to be paged.

One or more reporting UE devices generate a neighbor list that identifies neighbor devices of the reporting UE device and other information. The other information facilitates determining or estimating, either independently or with additional information derived from other means, the location of the neighbor devices. The neighbor lists are reported to base stations which may forward the neighbor list, or may forward data extracted, filtered, or derived from the neighbor list (NL), to the core network (CN) and/or to other base stations.

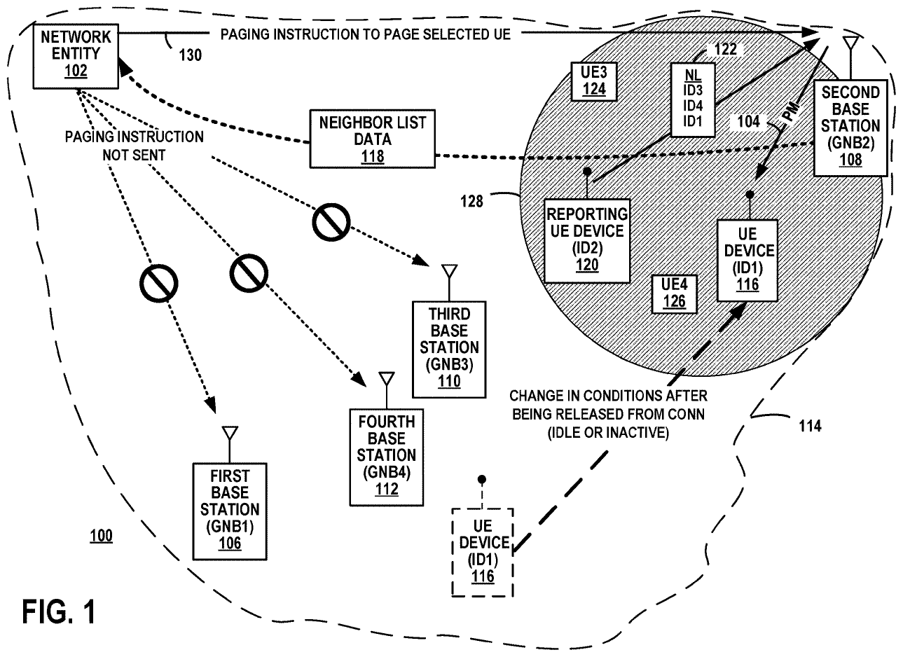

FIG. 1 is a block diagram of a communication system 100 where a network entity 102 limits transmission of a paging message 104 from less than all of the base stations 106, 108, 110, 112 in a paging area 114 to a selected UE device 116 to be paged based on neighbor list data 118. Reporting UE devices 120 generate a neighbor list (NL) 122 that includes a list of UE identifiers of neighbor UE devices. In the interest or clarity and brevity, a single reporting UE device 120 generates the NL 122 in the example of FIG. 1 where the NL 122 includes UE identifiers of the selected UE device 116 and two other neighbor UE devices 124, 126. The NL 122 includes ID1 of the selected UE device 116, ID3 of the neighbor UE device 124 and ID4 of the neighbor UE device 126. In many situations, however, multiple reporting UE devices send NLs to their serving base station. The techniques discussed herein, therefore, may be applied to processing multiple NLs from multiple reporting UE devices in making evaluations regarding selected UE device locations and paging management. In some situations, each base station selects the UE devices that report their NLs to the base station. As discussed below, a base station may send a reporting UE selection message to instructs a UE to report its NL. The message may be broadcasted or sent using direct signaling. A reporting UE device sends a NL message when in RRC_CONNECTED where the NL messages may be sent at specified times, periodically, in response to a request from the base station, or in response to a trigger. The network entity 102 is a component of the communication system 100 and may be, or may be part of, a base station (gNB) or the core network (CN).

As discussed herein, a reporting UE device is a UE device that generates a neighbor list and reports at least some of the data from the neighbor list to its serving base station. For the examples herein, the reporting UE device measures the quality of the direct communication links to other UE devices and includes UE devices having direct links to the reporting UE device that meet a minimum threshold. A UE identifier of each UE device meeting the criteria for the neighbor list is included in the neighbor list.

In some situations, the NL consists of UE IDs of neighboring devices with successful transmissions received at the reporting UE device. In one example, a neighbor UE device is included in the NL when discovery messages transmitted from the neighbor UE device are successfully received in the previous S timeslots where S is pre-defined network-wide parameter known to all the devices. The reporting UE device receives the discovery messages from its neighbor UE devices to identify all its immediate neighbors and builds a NL which includes the Layer 2 IDs of the identified neighboring devices. In some situations, a UE device transmitting a discovery message includes the cell ID of the cell on which the UE device is camped. As part of the mechanism to support Sidelink Relay path switch, for example, a relay UE device may send a discovery message that includes the cell ID. Other UE transmitted Reference Signals such as the Sounding RS (SRS), and/or CSI-RS reports transmitted by the neighboring UE devices may also be used for identifying and listing the neighboring UE devices.

In some situations, other types of identifiers may be used to identify the UE neighbor devices. For example, a Temporary Mobile Subscriber Identity (S-TMSI) is based on the Mobility Management Entity (MME) or Access & Mobility Management Function (AMF) code (MMEC) and the M-TMSI (S-TMSI=MMEC+M-TMSI) and uniquely identifies the UE device within an MME or AMF group. For paging purposes, the UE device in IDLE is paged with the S-TMSI. An Inactive-Radio Network Temporary Identifier (I-RNTI) can be allocated to a UE device within an RRCRelease message when releasing the UE device from RRC_CONNECTED to RRC_INACTIVE. Where a neighboring UE device provides the either of these identifiers, a UE generating a NL can include the identifier in the NL. In accordance with some examples, a UE device is instructed to provide the S-TMSI or I-RNTI in discovery signals.

In most situations, only those devices within the D2D communication range are included in an NL. As a result, the UE devices utilize the received signal strength as a proxy for distance of all the neighboring UE devices. The neighboring UE devices are added or removed from the NL if the measured signal strength is greater or less than a signal strength threshold (e.g., SignalStrength_{Threshold}), respectively. Where the reporting UE device has multi-antennas, then reporting UE device may also measure the received sidelink signal's Angle-of-Arrival (SL AoA) to get the direction of the neighboring UE device's transmission. In another approach, if the UE devices have the location determination capabilities UE devices may include their geo-location information in their respective sidelink transmissions. For example, a UE device may send Global Positioning Satellite (GPS) coordinates, Global Navigation Satellite System (GNSS) coordinates and/or indoor location. All the above methods or a subset of these methods, as well as other techniques, can be used to build the NL that includes both the neighboring device IDs and the associated geo-locations.

For the example of FIG. 1, the second base station (gNB 2) 108 is the serving base station of the reporting UE device 120 that sends the NL 122 to the second base station 108. In some situations, the reporting UE device 120 may send filtered data or data derived from the NL 122 rather than the NL 122 itself. Accordingly, the neighbor list (NL) 122 transmitted to the second base station 108 is not necessarily identical to the neighbor list (NL) maintained at the reporting UE device 120. Neighbor list data 118 is forwarded by the base station 108 to the network entity 102 where the neighbor list data 118 at least includes some of the information contained in at least one NL received by the base station 108. The entire NL 122 received by the base station 108 may be forwarded in some situations. In some examples, the base station 108 receives multiple NLs from multiple reporting UE devices and may filter, process, manipulate, or otherwise manage the data, information, and/or indications in the multiple NLs to generate the neighbor list data 118.

For some standards defined by the 3rd Generation Partnership Project (3GPP), the Radio Resource Control (RRC) include RRC_CONNECTED and RRC_IDLE. The standards for 5G or New Radio (NR) define a new state for the UE device of inactive (RRC_INACTIVE). RRC_INACTIVE is a state where the UE device remains in a connected management connected state (CM-CONNECTED) and can move within an area configured by the New Generation (NG)-Radio Access Network (RAN) RAN-based Notification Area (RNA) without notifying the NG-RAN. The RRC_INACTIVE state, therefore, is an RRC state in NR that is in addition to RRC_IDLE and RRC_CONNECTED. Connection Management (CM) is used to establish and release the control plane signaling connection between the UE device and the Access Management Function (AMF). The Connection Management depicts UE device status with respect to the device signaling with AMF 5G Core Node. Connection Management is used to transfer NAS signaling messages. Signaling Connection between the UE device and the AMF is based on the Uu interface sometimes known as a N1 logical interface and it is a combination of 1) RRC signaling between the UE and the gNB and 2) N2-AP signaling between the gNB and the AMF. The 3GPP has defined two Connection Management State for the UE device and AMF including Connection Management-Idle (CM-IDLE) and Connection Management-Connected (CM-CONNECTED). The CM-IDLE and CM-CONNECTED states are maintained at the NAS layer at both the UE device and the AMF. When the UE device is in the RRC_INACTIVE state, therefore, it is still in the CM_CONNECTED state. In RRC_INACTIVE, the last serving gNB node keeps the UE context and the UE-associated NG connection with the serving Access and Mobility Management Function (AMF) and the User Plan Function (UPF). A UE device in the RRC_INACTIVE state is required to initiate the RNA update procedure when it moves out of the configured RNA. When receiving an RNA update request from the UE device, the receiving gNB triggers the XnAP Retrieve UE Context procedure to get the UE context from the last serving gNB and may decide to send the UE device back to RRC_INACTIVE state, move the UE device into RRC_CONNECTED state, or send the UE device to RRC_IDLE. Where reestablishment of the RRC_CONNECTED state is initiated by the CN from IDLE or the serving base station from INACTIVE, the selected UE device is paged.

For the example, therefore, the selected UE device 116 is released from RRC_CONNECTED to either RRC_IDLE or RRC_INACTIVE while being served by a base station other than the second base station 108. For the scenario in FIG. 1, conditions change such that the UE device 116 is within the service area 128 of the second base station 108 after the selected UE device 116 is released from RRC_CONNECTED. The selected UE device 116, may move into the service area 128 at some point after entering RRC_INACTIVE or RRC_IDLE, for example. Since the selected UE device 116 is in RRC_INACTIVE or RRC_IDLE, the second base station 108 does not receive any signaling from the selected UE device 116. As a result, the second base station 108 would not detect the presence of the selected UE device 108.

Since the selected UE device 116 may still send and receive discovery signals while in the RRC_INACTIVE and RRC_IDLE states, however, nearby UE devices detect the selected UE device 116. If the D2D link between a detecting UE device and the selected UE device meets the appropriate criteria, the selected UE device 116 is added to the neighbor list of the detecting UE device. For the example of FIG. 1, the selected UE device 116 is being served by a base station other than the second base station 108 when the selected UE device 116 is released from the RRC Connected (RRC_CONNECTED) state to a state other than RRC_CONNECTED. In one scenario discussed in further detail below, the selected UE device is released to the RRC_IDLE state. In another scenario also discussed in further detail below, the selected UE device 116 is released to the RRC-INACTIVE state.

For both scenarios noted above, the network entity 102 evaluates the neighbor list data 118 to identify a subset of the base stations in the paging area that should transmit a paging message to the selected UE device to be paged. When the network entity 102 is notified or otherwise determines that the selected UE device 116 needs to be paged, the network entity 118 evaluates neighbor list data 118 which includes at least information (e.g., UE ID) identifying the selected UE device 116 and information that allows the network entity 118 to determine at least an approximate geographical location of the selected UE device 116. The geographical location is associated with one or more base stations that are providing at least one cell that at least potentially has a coverage area including the location of the selected UE device 116. For example, the neighbor list data 118 may indicate that the reporting UE device 120 provided a neighbor list 122 that includes a device ID of the selected UE device 116 and some information regarding the location of the reporting UE device 120 that allows the network entity 102 to identify one or more base stations for transmitting the paging message. Some examples of the other information useful in determining the selected UE device location include a cell ID of the cell on which the selected UE device is camped, the geographical location as determined by the selected UE device (GNSS coordinates, GPS coordinates, network assisted location, and AoA information of signals received by the selected UE device 116. Another example of information related to location includes signal strength information of signals transmitted by the selected UE device as received at one or more reporting UE devices. In some situations, camera data, radar, lidar, and/or radio frequency signals can be used to determine the location of the UE device.

After evaluating the neighbor list information 118, and any additional information obtained through other sources, the network entity 102 identifies at least one cell that should transmit the paging message to the UE selected UE device 116. The network entity 102 instructs the base station providing the cell to transmit a paging message to the selected UE device 116. For the example of FIG. 1, the network entity 102 sends a paging instruction 130 to the second base station 108 instructing the second base station to transmit a paging message 104 to the selected UE device 116. In response, the second base station 108 transmits a paging message 104 to the selected UE device 116 in accordance with known techniques. Where multiple base stations are selected to transmit a paging message, the network entity 102 sends a paging instruction 130 to each base station and each base station sends a paging message 104 to the selected UE device 116 to be paged.

The exemplary technique discussed with reference to FIG. 1 provides and efficient paging message management procedure that minimizes, or at least reduces, the number of base stations transmitting paging messages in a paging area 114. At least some paging instructions 132-134 that are sent to base stations 106, 110, 112 in conventional systems are not sent in accordance with the example of FIG. 1. Accordingly, a subset of base stations in the paging area 114 transmit a paging message for the selected UE device 116 where the subset includes a single base station for the example of FIG. 1.

Although the techniques discussed herein may be applied to various types of systems and communication specifications, the devices of the example operate in accordance with at least one revision of a 3GPP New Radio (NR) V2X communication specification. The techniques discussed herein, therefore, may be adopted by one or more future revisions of communication specifications although the techniques may be applied to other communication specifications where sidelink or D2D is employed. More specifically the techniques may be applied to current and future releases of 3GPP NR specifications. For example, the techniques may also be applied to 3GPP NR (Rel-17). For the example, the UE devices 116, 120, 122, 124, 126 may be any type of device that can receive signals from, and transmit signals to, base stations and other UE devices. The UE devices operate in the communication system that includes a plurality of base stations 106, 108, 110, 112 that each provide wireless service within a service area. For the example of FIG. 1, the UE devices 116, 120, 122, 124, 126 may be served by any one of the base stations and may transition between base stations in accordance with known handover techniques. Each of the UE devices 116, 120, 122, 124, 126, therefore, may be served by a different base station even though two or more UE devices are communicating with each other using a sidelink connection. A UE device may be in RRC_IDLE or RRC_INACTIVE relative to the base stations when communicating using sidelink.

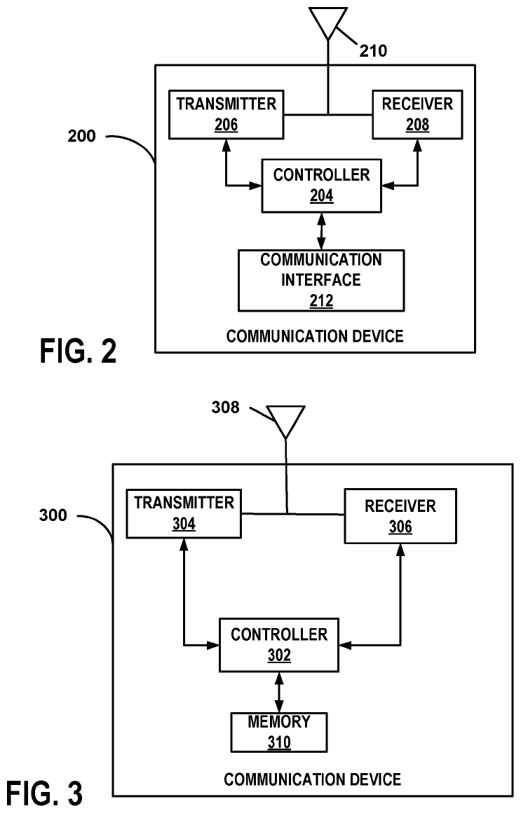

FIG. 2 is a block diagram of an example of a base station 200 suitable for use as any of the base stations 106, 108, 110, 112. The base station 200 includes a controller 204, transmitter 206, and receiver 208, as well as other electronics, hardware, and code. The base station 200 is any fixed, mobile, or portable equipment that performs the functions described herein. The various functions and operations of the blocks described with reference to the base stations 106, 108, 110, 112 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. In some circumstances, the antenna 210 may include multiple transmit and receive antennas.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the base station functions. The required components may depend on the particular functionality required by the base station.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

FIG. 3 is a block diagram of an example of a UE device 300 suitable for use as each of the UE devices 116, 120, 124, 126. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

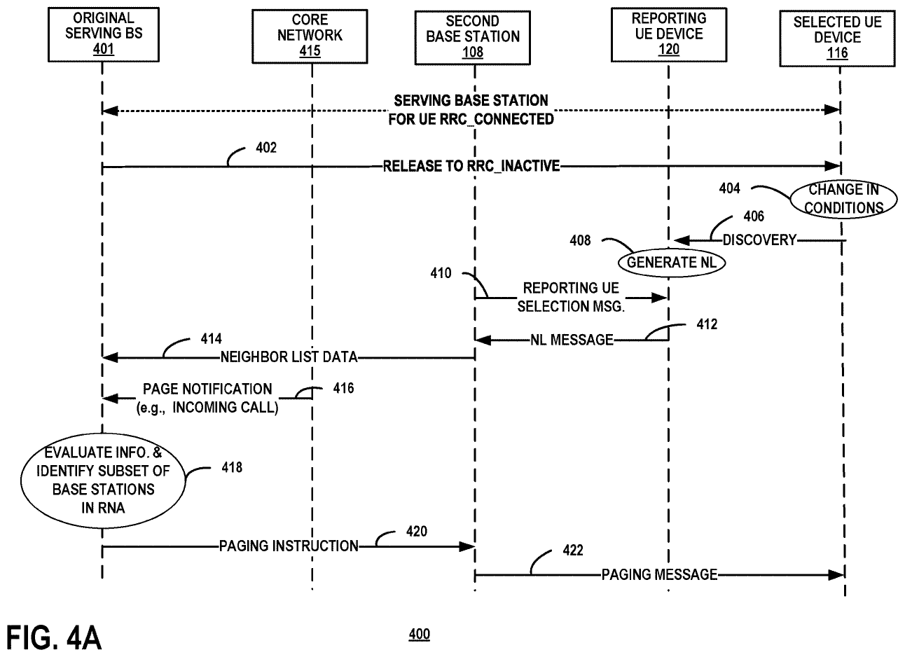

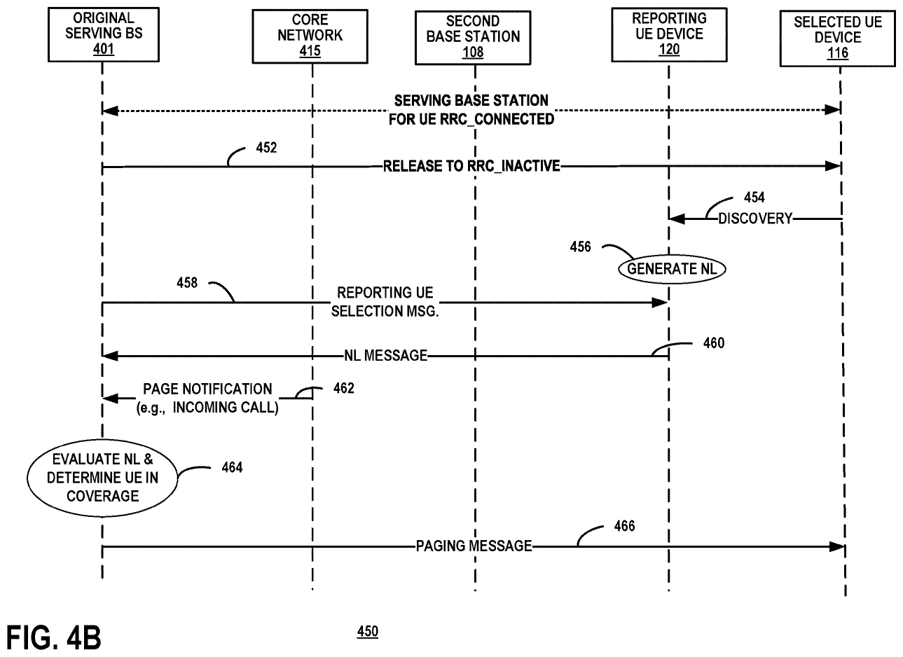

FIG. 4A is a message flow diagram 400 for an example where the selected UE device 116 is in the RRC_INACTIVE state and the original serving base station 401 identifies a subset of base stations for transmitting a paging message in the Radio Access Network (RAN) based Notification Area (RNA) where the subset may include a single base station. The example begins with the selected UE device in the RRC CONNECTED state with an original serving base station 401. At transmission 402, a release to INACTIVE message is transmitted from the original serving base station 401 to the selected UE device 116. For the example, the transmission 402 is a RRCRelease message with a suspendConfig parameter.

At event 404, a change in conditions occurs. For the example of FIG. 4A, the selected UE device moves to a new location within a cell of a second base station 108. In another example discussed below, the selected UE device 116 remains camped on the original serving base station 401.

At transmission 406, the selected UE device 116 transmits a discovery signal that is detected and received by a reporting UE device. The discovery signal may be a Model A or Model B discovery signal. For the example, the sidelink discovery signals include either Layer 2 ID, S-TMSI or I-RNTI. The UE devices may be instructed by a base station to include S-TMSI or I-RNTI where the instruction may be provided via SIB or dedicated signaling.

The reporting UE device 120 evaluates discovery signals (or other reference signals) transmitted by other UE devices to generate a NL. For the example, the reporting UE device 120 determines that the discovery signal transmitted by the selected UE device 116 meets the minimum criteria for including the selected UE device 116 in the NL. Accordingly, the reporting UE device 120 generates a NL that includes at least the selected UE device 116. As discussed below, the NL may include location-related information in addition to the identification of neighbor devices.

At transmission 410, the second base station 108 sends a reporting UE device selection message to the reporting UE device. The message 410 may be sent at any time and instructs the reporting UE device to forward neighbor list data to the second base station. The message 410 may be broadcasted or sent specifically to the UE devices selected to be reporting UE devices.

At transmission 412, the reporting UE device 120 sends a NL message to the second base station 108. The NL message includes at least some of the information contained in the NL 122. For the example, the NL message identifies each neighbor device of the reporting UE device 120 and provides location-related information. Some examples of location-related information include an indication of the serving cell of the selected UE device 116, an indication of the location of each neighbor device in the NL (e.g., GNSS coordinates of selected UE device) and information provided in the NL that allows a base station to calculate or otherwise determine the location of the selected UE device 116 (e.g., SL-AoA, SL signal strength of discovery signal received at reporting UE device 120).

At transmission 414, the second base station 108 sends neighbor list data to the original serving base station 401. In some situations, the neighbor list data is the same data and information received in NL messages from the reporting UE devices in the cell(s) of the second base station. In other situations, the second base station 108 filters, evaluates, or otherwise processes the data and information received in the received NL messages to generate the NL data to forward to the original serving base station. The NL data may include data and information received in multiple NL messages received from multiple reporting UE devices.

In one scenario, the second base station 108 sends the neighbor list data to all base stations in the RAN. In other situations, the second base station 108 may be more selective and only send the NL data to one base station or a subset of base stations in the RAN. As discussed below, for example, where the second based station 108 can identify the original serving base station, the second base station may send the NL data to the original serving base station.

The transmission 414 may be in response to an event or message in some situations. Where the second base station determines that a UE device listed in the NL was originally served by the original serving base station before being released to INACTIVE, for example, the second base station may identify the original serving base station as a base station that should receive the NL data that includes information at least related to the UE device. Such a determination may be based on the information transmitted in the discovery signal and conveyed by the reporting UE device in the NL message. In other situations, the original serving base station may send a message requesting NL data and the second base stations send the NL data in the transmission 414 in response to the request. For example, the original serving base station may determine that the selected UE is likely no longer within a cell of the original serving base station's coverage and, in response, may send request messages to nearby base stations to receive NL data. In conventional systems, a base station cannot determine whether a UE device released to RRC_INACTIVE is still within coverage of the base station. In one example that may be used with the techniques discussed herein, the original base station evaluates the NL messages received from the reporting UE devices in service area of the original base station to determine whether the selected UE device has left the service area. If the selected UE device transmits discovery signals, a reporting UE device in the service area may include the selected UE device in its NL and report the NL to the original serving base station. Since it is possible that the selected UE device may not transmit discovery signals or the D2D link to the reporting UE device does not meet the NL criteria, it is possible that the selected UE device is still in the area even though no reporting UE device reported the selected UE device in an NL message. In such a technique, therefore, a suitable example of a paging management procedure includes reverting to the legacy method of sending the paging instruction to all the base stations in the RAN if no reporting UE device reports an NL including the selected UE device.

In another example where the original serving base station requests a NL data from other base station in the RAN, the original serving base station sends a request to all base stations in the RAN for NL data related to each UE device released to INACTIVE by the original serving base station. Such a request includes a UE identifier identifying each UE device released to INACTIVE by the original serving base station.

In some situations, the discovery signal transmitted by the selected UE device includes an original serving base station identifier that identifies the original serving base station 401. The reporting UE device 120 includes the original serving base station identifier in the NL message sent to the second base station 108. The second base station 108 evaluates the NL message to determine the original serving base station of the selected UE device and sends the NL data to the original serving base station. In this way, the second base station can send the NL data regarding a particular UE device only to the base station that released that UE device and that was identified as a neighbor UE in the NL message received at the second base station. Accordingly, the second base station 108 may send different NL data to each of several base stations.

The transmission 414 can be sent over any suitable wired and/or wireless backhaul. For the example, the transmission is sent over an X2/Xn interface. In some situations, the NL data may be sent to the core network (CN) 415, either alternatively or in addition to sending the NL data to the original serving base station 401.

At transmission 416, a page notification is received at the original serving base station. The page notification is any message, indicator, or notification that indicates the selected UE device should be paged to initiate a transition to RRC-CONNECTED. In most situations, the page notification is an incoming call message indicating that there is data available for the selected UE device. The page notification message may also be an indication that a particular service requested by the selected UE device that was previously unavailable has become available. For example, where services become temporary unavailable, the base station may release UE devices requesting the service to INACTIVE rather than keeping the UE devices in CONNECTED and then have the UE devices paged when the service becomes available or activated. In this way, the base station can reduce the network load by releasing several UE devices to INACTIVE (e.g., no need to handle mobility which includes frequent measurement reports) if the UE devices are only interested in a particular type of service. One such service discussed in Rel-18 of the 3GPP communication standard is the multicast service. Multicast service typically requires a relatively high QoS to targeted UE devices and, therefore, is preferably handled in RRC_CONNECTED. The page notification may be a message indicating that the multicast service is available. The paging notification message may also be related to other types of services and situations, such as those related to E911 situations, M2M type applications, and robo-vehicle UE devices.

In response to receiving the page notification, the original serving base station 401 evaluates NL data to determine the likely location of the selected UE device 116 that is to be paged. Based on the NL data in the example of FIG. 4A, the original serving base station 401 identifies the second base station 108 as the base station that should send a page since the NL data indicates that the selected UE device is located within a cell of the second base station 108. In one example, the NL data includes the cell ID of the serving cell of the selected UE device 116 and the original serving base station 401 identifies the second base station 108 as the serving base station based on the cell ID. In a second example, the NL data includes location coordinates, such as GNSS coordinates, and the original serving base station 401 determines and maps the location to the serving cell. In a third example, the original serving base station 401 calculates or determines the location of the selected UE device 116 based on location-related information in the NL data such as, for example, AoA and signal strength of the received discovery signal at the reporting UE device. For the second and third examples, the original serving base station 401 may invoke assistance from the Location Management Server (LMS) to calculate the selected UE device location. The mapping of the location to the cell ID may be performed by the original serving base station 401, the LMS, or a combination of the two. Other entities and servers in addition to the LMS may be used to perform the location and mapping functions in some situations.

The original serving base station 401 selects one or more base stations within the RNA to transmit a paging message for the selected UE device. For the example, the original serving base station 401 selects the second base station 108 as the single base station to transmit the paging message. The original serving base station 401, therefore, selects a subset of all the base stations in the RNA for transmitting the paging message where the subset may include only one base station.

At transmission 420, the original serving base station 401 sends a paging instruction to the second base station instructing the second base station to page the selected UE device 116. The paging instruction is in accordance with conventional paging instructions that are sent to all of the base stations in the RNA except that the paging instruction in the example of FIG. 4A is only sent to the second base station 108. The paging instruction 420 is sent over any suitable wired and/or wireless backhaul. For the example, the transmission is sent over an X2/Xn interface.

At transmission 422, the second base station 108 sends a paging message to the selected UE device 116. The transmission 422 initiates a procedure for the selected UE device to transition from the RRC_INACTIVE state to the RRC_CONNECTED state. While in RRC INACTIVE, the selected UE device 116 monitors the paging channels for RNA-initiated paging. As is known, the UE device does not need to monitor paging channels continuously. Paging DRX is defined where the UE device in RRC_INACTIVE is only required to monitor paging channels during one Paging Occasion (PO) per DRX cycle.

FIG. 4B is a message flow diagram 450 for an example where the selected UE device 116 is in the RRC_INACTIVE state and the original serving base station 401 determines that the selected UE device 116 is within a cell of the original serving base station 401 when the selected UE device is paged. The example begins with the selected UE device 116 in the RRC_CONNECTED state with an original serving base station 401. At transmission 452, a release to INACTIVE message is transmitted from the original serving base station 401 to the selected UE device 116. For the example, the transmission 452 is a RRCRelease message with a suspendConfig parameter. The example of FIG. 4B, therefore, is similar to the example of FIG. 4A but differs in that the reporting UE device 120 is within the coverage area of the original serving base station, rather than within the coverage area 128 of the second base station 108. In a typical scenario, each base station sends a reporting UE selection message to the UE devices in its service area selected to be reporting UE devices. Accordingly, NL messages are received by each base station from the reporting UE devices in the base station's coverage area. The example of FIG. 4B is directed to the situation where the reporting UE device and the selected UE device are within the coverage area 128 of the original serving base station 401. The description of events and transmissions in regard to FIG. 4A apply to similar events and transmission related to FIG. 4B.

At transmission 454, the selected UE device 116 transmits a discovery signal that is detected and received by a reporting UE device 120. The discovery signal may be a Model A or Model B discovery signal. For the example, the sidelink discovery signals include either Layer 2 ID, S-TMSI or I-RNTI. The UE devices may be instructed by a base station to include S-TMSI or I-RNTI where the instruction may be provided via SIB or dedicated signaling.

The reporting UE device 120 evaluates discovery signals (or other reference signals) transmitted by other UE devices to generate an NL. For the example, the reporting UE device 120 determines that the discovery signal transmitted by the selected UE device 116 meets the minimum criteria for including the selected UE device 116 in the NL. Accordingly, the reporting UE device 120 generates an NL that includes at least the selected UE device 116. As discussed below, the NL may include location-related information in addition to the identification of neighbor devices. As compared to the example of FIG. 4A, the selected UE device 116 does not move out of coverage of the original serving base station 401 in the example of FIG. 4B. Accordingly, the reporting UE device 120 is within a cell of the original serving base station 401 for the example of FIG. 4B.

At transmission 458, the original serving base station 401 sends a reporting UE device selection message to the reporting UE device 120. The message transmission 458 may be sent at any time and instructs the reporting UE device 120 to forward neighbor list data to the original serving base station 401. The message 458 may be broadcasted or sent over dedicated signaling to the UE devices selected to be reporting UE devices.

At transmission 460, the reporting UE device 120 sends an NL message to the original serving base station 401. The NL message includes at least some of the information contained in the NL. For the example, the NL message identifies each neighbor device of the reporting UE device 120 and provides location-related information. Some examples of location-related information include an indication of the serving cell of the selected UE device 116, an indication of the location of each neighbor device in the NL (e.g., GPS coordinates of selected UE device) and information provided in the NL that allows a base station to calculate or otherwise determine the location of the selected UE device 116 (e.g., SL-AoA, SL signal strength of discovery signal received at reporting UE device 120).

At transmission 462, a page notification message is received at the original serving base station 401. As described above, the page notification may be an incoming call message.

In response to receiving the page notification, the original serving base station 401 evaluates NL data at event 464 to determine the likely location of the selected UE device 116 that is to be paged. The original serving base station 401 determines from the NL data that the selected UE device 116 is located within a cell of the original serving base station 401. In one example, the NL data includes the cell ID of the serving cell of the selected UE device 116 and the original serving base station 401 determines that it is still the serving cell of the selected UE device 116. In a second example, the NL data includes location coordinates, such as GPS coordinates, and the original serving base station 401 determines and maps the location to the serving cell. In a third example, the original serving bases station 401 calculates or determines the location of the selected UE device 116 based on location-related information in the NL data such as, for example, AoA and signal strength of the received discovery signal at the reporting UE device. For the second and third examples, the original serving base station 401 may invoke assistance from the Location Management Server (LMS) to calculate the selected UE device location. The mapping of the location to the cell ID may be performed by the original serving base station, the LMS, or a combination of the two. Other entities and servers in addition to the LMS may be used to perform the location and mapping functions in some situations.

At transmission 466, the original serving base station 401 sends a paging message to the selected UE device. The transmission 466 initiates a procedure for the selected UE device to transition from the INACTIVE state to the CONNECTED state.

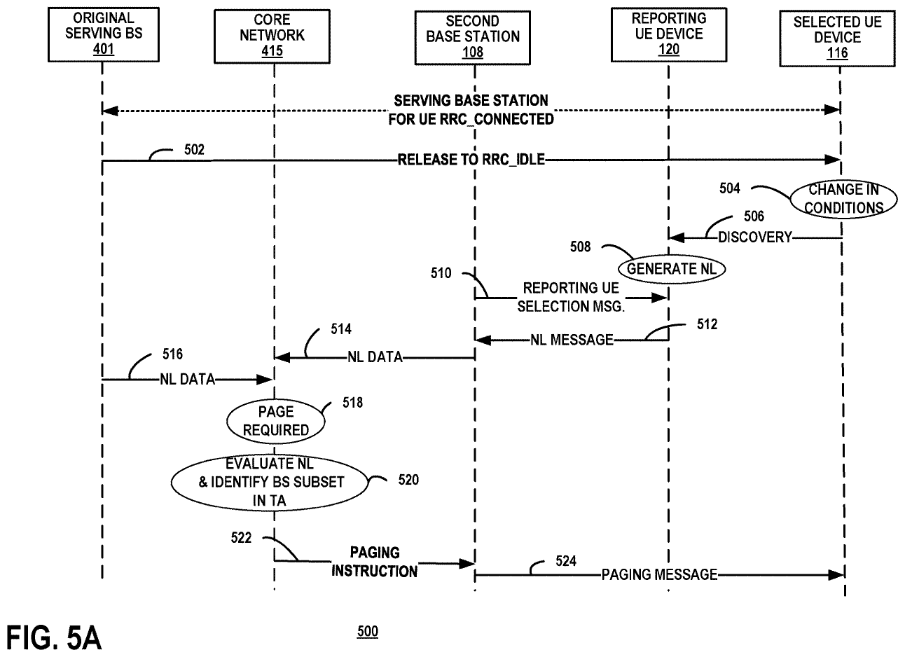

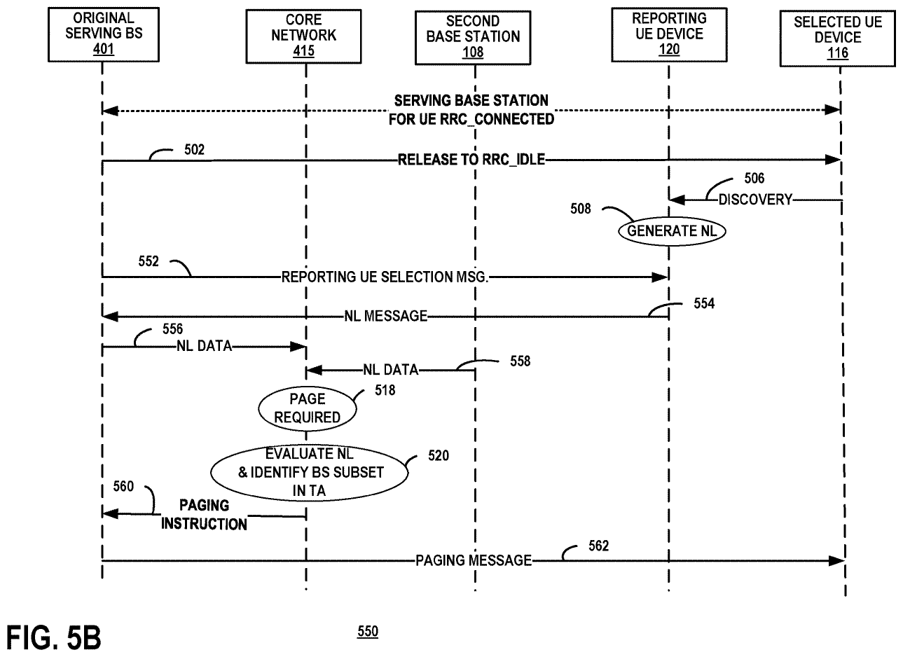

FIG. 5A is a message flow diagram 500 for an example where the selected UE device is in the RRC_IDLE state and the original serving base station 401 identifies a subset of base stations for transmitting a paging message in the Tracking Area (TA). The example begins with the selected UE device in the RRC_CONNECTED state with an original serving base station 401.

At transmission 502, a release to IDLE message is transmitted from the original serving base station 401 to the selected UE device 116. For the example, the transmission 502 is a RRCRelease message. The transition to RRC-IDLE may be initiated by the CN or by the UE device. Where the UE device determines that the its RRC connection should be released, it initiates the transition by generating and sending an RRC Release Indication message. In response to receiving the RRC Release Indication from the UE device, the network's radio access network acknowledges the release by acknowledging the message.

At event 504, a change in conditions occurs. For the example of FIG. 5A, the selected UE device moves to a new location within a cell of a second base station 108. In another example discussed below, the selected UE device 116 remains camped on the original serving base station 401.

At transmission 506, the selected UE device 116 transmits a discovery signal that is detected and received by a reporting UE device 120. The discovery signal may be a Model A or Model B discovery signal. For the example, the sidelink discovery signals include either Layer 2 ID, S-TMSI or I-RNTI. The UE devices may be instructed by a base station to include S-TMSI or I-RNTI where the instruction may be provided via SIB or dedicated signaling.

The reporting UE device 120 evaluates discovery signals (or other reference signals) transmitted by other UE devices to generate a NL. For the example, the reporting UE device determines that the discover signal transmitted by the selected UE device 116 meets the minimum criteria for including the selected UE device 116 in the NL. Accordingly, the reporting UE device 120 generates a NL that includes at least the selected UE device 116. As discussed below, the NL may include location-related information in addition to the identification of neighbor devices.

At transmission 510, the second base station 108 sends a reporting UE device selection message to the reporting UE device 120. The message 510 may be sent at any time and instructs the reporting UE device 120 to forward neighbor list data to the second UE device 108. The message 510 may be broadcasted or sent specifically to the UE devices selected to be reporting UE devices.

At transmission 512, the reporting UE device 120 sends a NL message to the second base station. The NL message includes at least some of the information contained in the NL. For the example, the NL message identifies each neighbor device of the reporting UE device and provides location-related information. Some examples of location-related information include an indication of the serving cell of the selected UE device 116, an indication of the location of each neighbor device in the NL (e.g., GNSS coordinates of selected UE device) and information provided in the NL that allows a base station to calculate or otherwise determine the location of the selected UE device (e.g., SL-AoA, SL signal strength of discovery signal received at reporting UE device).

At transmission 514, the second base station 108 sends neighbor list data to the core network (CN) 415. In some situations, the neighbor list data is the data and information received in NL messages from the reporting UE devices in the cell(s) of the second base station 108. In other situations, the second base station 108 filters, evaluates, or otherwise processes the data and information received in the received NL messages to generate the NL data to forward to the CN 415. Accordingly, the NL data may include only information for particular UE devices. The NL data may include data related only to UE devices in RRC_IDLE, for example.

The transmission 514 may be in response to an event or message in some situations. Where the second base station 108 determines that a UE device listed in the NL is in IDLE, for example, the second base station may make the determination that the CN 415 should be made aware of the location. Such a determination may be based on the information transmitted in the discovery signal and conveyed by the reporting UE device 120 in the NL message. In other situations, the CN 415 may send a message requesting NL data and the second base station 108 sends the NL data in the transmission 514 in response to the request.

At transmission 516, the original serving base station 401 sends NL data to the core network (CN) 415 where the NL data is based on the NL messages received from reporting UE devices being served by the original serving base station 401. The CN 415 may receive NL data from multiple base stations, therefore. The transmissions 514, 516 can be sent over any suitable wired and/or wireless backhaul. For the example, the transmissions are sent over an X2/Xn interface.

At event 518, the CN 415 determines that the selected UE device should be paged. For example, the CN 415 may determine that there is an incoming call for the selected UE device 116.

In response to determining that the selected UE device should be paged, the CN 415 evaluates NL data at event 520 to determine the likely location of the selected UE device. The CN 415 identifies the second base station 108 as the base station that should send a page based on the NL data indicating that the selected UE device 116 is located within a cell of the second base station 108. In one example, the NL data includes the cell ID of the serving cell of the selected UE device and the CN identifies the second base station as the serving base station based on the cell ID. In a second example, the NL data includes location coordinates, such as GPS coordinates, and the CN 415 determines and maps the location to the serving cell. In a third example, the CN 415 calculates or determines the location of the selected UE device based on location-related information in the NL data such as, for example, AoA and signal strength of the received discovery signal at the reporting UE device. For the second and third examples, the CN 415 may invoke assistance from the Location Management Server (LMS) to calculate the selected UE device location. The mapping of the location to the cell ID may be performed by the CN 415, the LMS, or a combination of the two. Other entities and servers in addition to the LMS may be used to perform the location and mapping functions in some situations.

The CN 415 selects one or more base stations within the TA to transmit a paging message for the selected UE device where the number of base stations selected is less than the total number of base stations in the TA. For the example, the CN 415 selects the second base station 108 as the single base station to transmit the paging message. The CN 415, therefore, selects a subset of all the base stations in the TA for transmitting the paging message where the subset may include only one base station.

At transmission 522, the CN 415 sends a paging instruction to the second base station 108 instructing the second base station 108 to page the selected UE device 116. The paging instruction is in accordance with conventional paging instructions that are sent to all of the base stations in the TA except that the paging instruction in the example is only sent to the second base station 108. The paging instruction 622 is sent over any suitable wired and/or wireless backhaul. For the example, the transmission is sent over an X2/Xn?? interface.

At transmission 524, the second base station 108 sends a paging message to the selected UE device 116. The transmission 524 initiates a procedure for the selected UE device 116 to transition from the RRC_IDLE state to the RRC_CONNECTED state. While in RRC IDLE, the selected UE device monitors the paging channels for CN-initiated paging. As is known, the UE device does not need to monitor paging channels continuously. Paging DRX is defined where the UE device in RRC_IDLE (or RRC INACTIVE) is only required to monitor paging channels during one Paging Occasion (PO) per DRX cycle, FIG. 5B is a message flow diagram 550 for an example where the selected UE device 116 is in the RRC_IDLE state and the CN 415 determines the selected UE device is within a cell of the original serving base station 401 when the selected UE device 116 is paged. The example begins with the selected UE device 116 in the RRC CONNECTED state with an original serving base station 401. At transmission 502, a release to IDLE message is transmitted from the original serving base station to the selected UE device. For the example, the transmission 502 is a RRCRelease message.

At transmission 506, the selected UE device transmits a discovery signal that is detected and received by a reporting UE device 120. The discovery signal may be a Model A or Model B discovery signal. For the example, the sidelink discovery signals include either Layer 2 ID, S-TMSI or I-RNTI. The UE devices may be instructed by a base station to include S-TMSI or I-RNTI where the instruction may be provided via SIB or dedicated signaling.

The reporting UE device 120 evaluates discovery signals (or other reference signals) transmitted by other UE devices to generate a NL. For the example, the reporting UE device 120 determines that the discovery signal transmitted by the selected UE device 116 meets the minimum criteria for including the selected UE device in the NL. Accordingly, the reporting UE device 120 generates a NL that includes at least the selected UE device. As discussed below, the NL may include location related information in addition to the identification of neighbor devices. As compared to the example of FIG. 5A, the selected UE device does not move out of coverage of the original serving base station in the example of FIG. 5B. Accordingly, the reporting UE device 120 is within a cell of the original serving base station 401 for the example of FIG. 5B.

At transmission 552, the original serving base station 401 sends a reporting UE device selection message to the reporting UE device. The message transmission 458 may be sent at any time and instructs the reporting UE device to forward neighbor list data to the original serving base station 401. The message 552 may be broadcasted or sent specifically to the UE devices selected to be reporting UE devices.

At transmission 554, the reporting UE device 120 sends a NL message to the original serving base station 401. The NL message includes at least some of the information contained in the NL generated by the reporting UE device 120. For the example, the NL message identifies each neighbor device of the reporting UE device 120 and provides location-related information. Some examples of location-related information include an indication of the serving cell of the selected UE device 116, an indication of the location of each neighbor device in the NL (e.g., GPS coordinates of selected UE device) and information provided in the NL that allows a base station to calculate or otherwise determine the location of the selected UE device (e.g., SL-AoA, SL signal strength of discovery signal received at reporting UE device).

At transmission 556, the original serving base station 401 sends NL data to the CN 415 where the NL data is based on the NL messages received from reporting UE devices being served by the original serving base station 401. The CN 415 may receive NL data from multiple base stations. For the example, the CN also receives NL data from the second base station 108 at transmission 558. The transmissions 556, 558 can be sent over any suitable wired and/or wireless backhaul. For the example, the transmission is sent over an X2/Xn interface.

At event 518, the core network determines that the selected UE device should be paged. For example, the CN may determine that there is an incoming call for the selected UE device.

In response to determining that the selected UE device 116 should be paged, CN 415 evaluates NL data at event 520 to determine the likely location of the selected UE device 116. The CN 415 identifies the original serving base station 401 as the base station that should send a page based on the NL data indicating that the selected UE device 116 is located within a cell of the original serving base station 401. In one example, the NL data includes the cell ID of the serving cell of the selected UE device and the CN identifies the second base station as the serving base station based on the cell ID. In a second example, the NL data includes location coordinates, such as GPS coordinates, and the CN 415 determines and maps the location to the serving cell. In a third example, the CN 415 calculates or determines the location of the selected UE device based on location-related information in the NL data such as, for example, AoA and signal strength of the received discovery signal at the reporting UE device. For the second and third examples, the CN 415 may invoke assistance from the Location Management Server (LMS) to calculate the selected UE device location. The mapping of the location to the cell ID may be performed by the CN 415, the LMS, or a combination of the two. Other entities and servers in addition to the LMS may be used to perform the location and mapping functions in some situations.

The CN 415 selects one or more base stations within the TA to transmit a paging message for the selected UE device. For the example, the CN 415 selects the original serving base station as the single base station to transmit the paging message. The CN 415, therefore, selects a subset of all the base stations in the TA for transmitting the paging message where the subset may include only one base station.

At transmission 560, the CN 415 sends a paging instruction to the original serving base station instructing the original serving base station to page the selected UE device. The paging instruction is in accordance with conventional paging instructions that are sent to all of the base stations in the TA except that the paging instruction in the example is only sent to the original serving base station. The paging instruction 560 is sent over any suitable wired and/or wireless backhaul. For the example, the transmission is sent over an X2/Xn interface.

At transmission 562, the original serving base station sends a paging message to the selected UE device. The transmission 562 initiates a procedure for the selected UE device to transition from the INACTIVE state to the CONNECTED state.

While in RRC IDLE, the selected UE device monitors the paging channels for CN-initiated paging. As is known, the UE device does not need to monitor paging channels continuously. Paging DRX is defined where the UE device in RRC_IDLE (or RRC_INACTIVE) is only required to monitor paging channels during one Paging Occasion (PO) per DRX cycle.

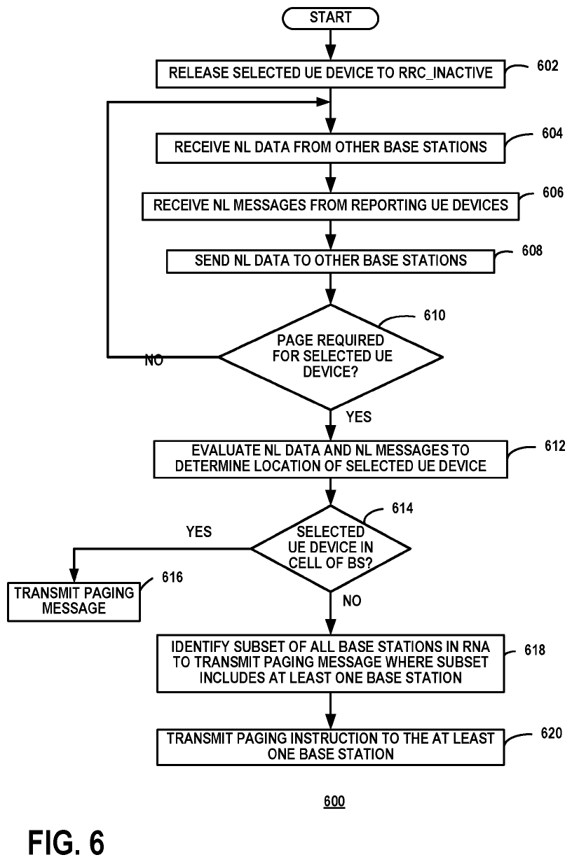

FIG. 6 is a flow chart of an example of a method 600 of managing UE device paging for UE devices in RRC_INACTIVE. For the example, the method is performed by a UE device operating in system in accordance with at least one revision of the NR V2X specification, such as the system 100 described above. Accordingly, the method may be performed by the original serving base station 401.

At step 602, the selected UE device 116 is released to RRC_INACTIVE. For the example, the original serving base station 401 sends a RRCRelease message with a suspendConfig parameter to the selected UE device to transition the selected UE device from RRC_CONNECTED to RRC-INACTIVE.

At step 604, NL data is received from other base stations. One or more base stations transmit NL data based on NL messages received from reporting UE devices. The NL data may be the forwarded NLs or NL messages or may be data derived from the received NL messages.

At step 606, NL messages are received from reporting UE devices. For the example, the reporting UE devices sending the NL messages were previously selected by the base station and notified with one or more messages that NL messages should be provided. The NL messages may include an NL or information derived from the NL generated at the reporting UE device.

At step 608, NL data derived from the received NL messages is transmitted to other base stations. The NL data may include the NL messages or NLs provide by the reporting UE devices. In some situations, the NL data transmission is in response to a request by another base station.

At step 610, it is determined whether the selected UE device should be paged. The CN 415 notifies the base station of incoming calls and other notifications related to paging and if there is an incoming call for the selected UE device (or other reason to page the UE device), the method proceeds to step 612. Otherwise, the method returns to step 604.

At step 612, the NL data and the received NL messages are evaluated to determine, or at least estimate, the location of the selected UE device. As discussed above, the location can be determined based on the information in the NL messages and NL data where the information or data may explicitly provide the location with geo-location coordinates or may provide information that allows the base station and/or other entities calculate the location.

At step 614, it is determined whether the selected UE device is within a cell of the original serving base station. If the selected UE device is within the service area of the original serving base station, the original serving base station transmits a paging message for the selected UE device at step 616. Otherwise, the method proceeds to step 618.

At step 618, subset of base stations of the base stations in the RNA is identified for transmitting a paging message where the subset includes at least one base station. Based on the location of the selected UE device, the original serving base station determines the base station on which the selected UE device is likely camped. In situations, where a precise location is not identified a small group of base stations may be identified where the selected UE device is likely within one of the cells of one of the base stations.

At step 620, a paging instruction is transmitted to the at least one base station to instruct the base station to transmit a paging message to the selected UE device.

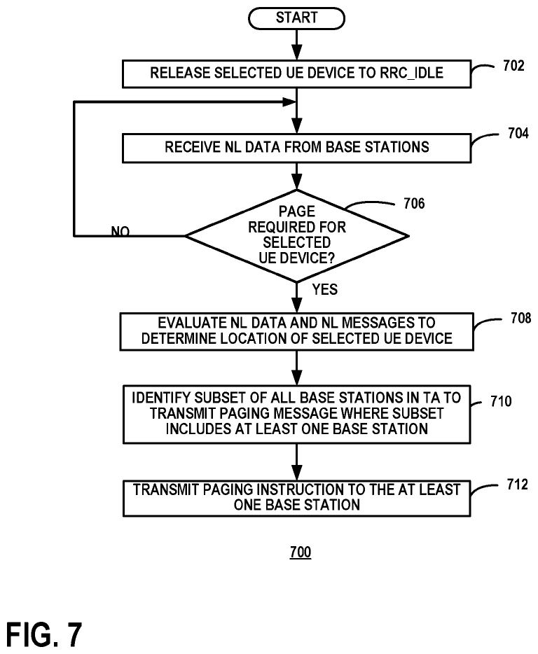

FIG. 7 is a flow chart of an example of a method 700 of managing UE device paging for UE devices in RRC_IDLE. For the example, the method is performed by a UE device operating in system in accordance with at least one revision of the NR V2X specification, such as the system 100 described above. Accordingly, the method may be performed by the CN 415.

At step 702, the selected UE device 116 is released to RRC_IDLE. For the example, the CN 15 invokes the original serving base station 401 to send a RRCRelease message to the selected UE device to transition the selected UE device from RRC_CONNECTED to RRC_IDLE.

At step 704, NL data is received from at least one base station. One or more base stations transmit NL data based on NL messages received from reporting UE devices. The NL data may be the forwarded NLs or NL messages or may be data derived from the received NL messages.

At step 706, the CN determine whether the selected UE device needs to be paged. If the selected UE device is to be paged, the method proceeds to step 708.

Otherwise, the method returns to step 704.

At step 708, the NL data is evaluated to determine, or at least estimate, the location of the selected UE device. As discussed above, the location can be determined based on the information from the NL data where the information or data may explicitly provide the location with geo-location coordinates or may provide information that allows the CN 415 and/or other entities calculate the location.

At step 710, subset of base stations of the base stations in the TA is identified for transmitting a paging message where the subset includes at least one base station. Based on the location of the selected UE device, the CN 415 determines the base station on which the selected UE device 116 is likely camped. In situations, where a precise location is not identified a small group of base stations may be identified where the selected UE device is likely within one of the cells of one of the base stations.

At step 712, a paging instruction is transmitted to the at least one base station to instruct the base station to transmit a paging message to the selected UE device.

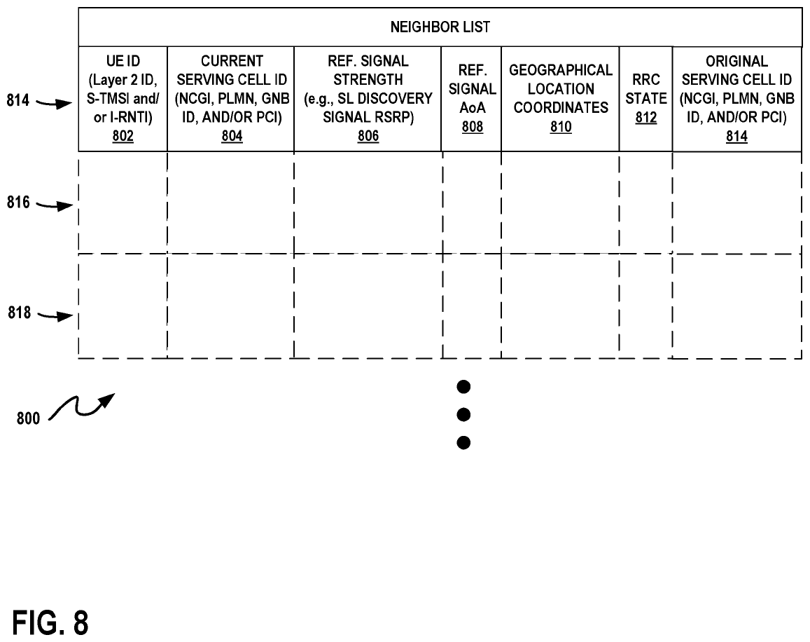

FIG. 8 is a block diagram of an example of a neighbor list (NL) message 800. Any of several configurations of the NL message 800 may be used as the NL messages discussed above including the NL message 122. For the example, the NL message 800 includes several parameters and information where some of the information may be omitted or combined with other information in different scenarios and situations.

The NL message at includes at least one UE identifier 802. Examples of UE identifiers include a Layer 2 ID, S-TMSI, and I-RNTI. In some situations, more than one UE identifier may be included. For example, the neighbor list message 800 may include the Layer 2 ID and the S-TMSI of the neighbor UE device.

The NL message 800 includes a current serving cell identifier 804 in some situations which identifies the current serving cell of the neighbor UE device. Examples of serving cell identifiers include NCGI, PLMN, GNB ID, and PCI. In some situations, more than one cell identifier may be included.

The NL message 800 may also include a reference signal strength 806. For example, the reporting UE device may measure the RSRP of the discovery signals transmitted from the neighbor UE device. The RSRP value or a value derived from the RSRP may be included in the NL message 800.

A reference signal angle-of-arrival (AoA) 808 provides information regarding the direction of the neighbor UE device from the perspective of the reporting UE device. The reporting UE device requires an appropriate antenna system for determining the AoA. Therefore, with the adequate antennas, the reporting UE device may measure the discovery signal transmitted from the neighbor UE device and determine the AoA which can be included in the NL message 800.

Where the neighbor device has the capability to determine its geo-location coordinates, the neighbor UE device can include the coordinates in the discovery signal. The reporting UE device can then provide the geo-location coordinates 810 in the NL message 800. In some situations, the reporting UE device may have the capability to determine the geo-location coordinates of the neighbor UE device and include the calculated coordinates in the NL message.

In some situations, the NL message includes an RRC state indicator 812 that indicates the whether the neighbor UE device is in RRC_CONNECTED, RRC_IDLE, or RRC_INACTIVE. The RRC state indicator 812 may be omitted as redundant in situations where other information included in the NL message indicates the RRC state. For example, where an I-RNTI is included as the UE ID, the NL message 800 indicates that the neighbor UE device is in RRC_INACTIVE.

The NL message 800 includes an original serving cell identifier 814 in some situations which identifies the original serving cell of the neighbor UE device. Examples of serving cell identifiers include NCGI, PLMN, GNB ID, and PCI. In some situations, more than one cell identifier may be included. The original serving cell identifier 814 identifies the base station that released the UE device from RRC-CONNECTED.

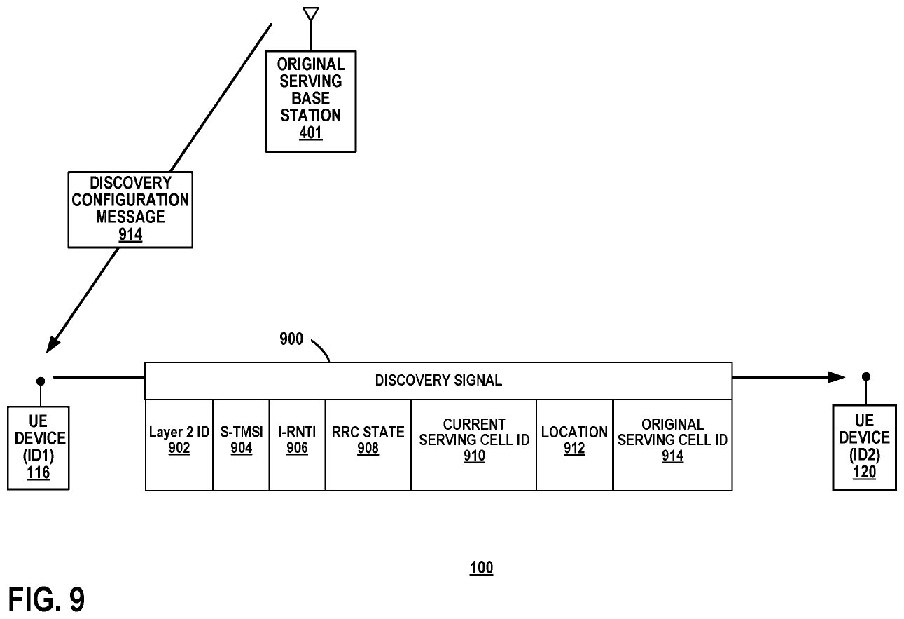

FIG. 9 is a block diagram of the system 100 for an example where a base station configures a UE device 116 to transmit SL discovery signals to include selected information and parameters. A SL discovery signal 900 transmitted from the selected UE device 116 may include several parameters and information. Any of several configurations of the discovery signal 900 may be used as the discovery signals discussed above including the discovery signals 406, 454, 506. For the example, the discovery signal 900 includes several parameters and information where some of the information may be omitted or combined with other information in different scenarios and situations.

The discovery signal includes at least one of a Layer 2 ID 902, S-TMSI 904, or an I-RNTI 906 to identify the UE device 116 transmitting the discovery signal 900. The discovery signal 900 may also include an RRC state parameter 908 indicating the RRC state. The cell ID 910 may indicate any combination of NCGI, PLMN, GNB ID, and PCI of the current serving cell of the UE device. In some situations where the UE device 116 has the capability to determine its location, the discovery signal may include a location parameter 912. The location parameter 912 may include geo-location coordinates such as GPS coordinates. In some situations, the discovery signal includes an original serving cell identifier 914 that identifies the original serving cell of UE device. Examples of serving cell identifiers include NCGI, PLMN, GNB ID, and PCI. In some situations, more than one cell identifier may be included. The original serving cell identifier 914 identifies the base station that released the UE device from RRC-CONNECTED.

The discovery signal 900 is received by the reporting UE device 120 that uses the parameters and information, as well as measurements taken on the discovery signal 900 to generate an NL. Accordingly, the information provided by the discovery signal 900 may determine what information is included in the NL and in any NL message transmitted to a base station.

For the example, the serving base station 108 transmits a discovery configuration message 914 to the UE device 116 to configure the discovery signal transmissions. Accordingly, the base station instructs the UE device 116 to transmit the S-TMSI, I-IRNTI and/or the Layer 2 UE ID in some circumstances. The discovery configuration message 914 is transmitted over SIB12 in the example.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A network entity comprising:
a network interface configured to receive neighbor list data at least partially based on a neighbor list generated by a reporting UE device, the neighbor list data comprising information and identifying at least one neighbor UE device of the reporting UE device; and
a controller configured to:
determine that a paging message is required for a selected UE device:
determine, based at least partially on the neighbor list data, that the neighbor list identifies the selected UE device; and
determine, at least partially based on the information, a location of the selected UE device within a paging area;
determine, a subset of base stations of all the base stations in the paging area,
the communication interface further configured to send a paging instruction to page the selected UE device, the communication interface configured to send the paging instruction to at least one base station in the subset of base stations.

2. The network entity of claim 1, wherein the selected UE device has been released from Radio Resource Control (RRC)_CONNECTED state.

3. The network entity of claim 2, wherein the neighbor list data comprises a UE identifier identifying the selected UE device.

4. The network entity of claim 3, wherein the UE identifier comprises at least one of a Layer 2 UE ID, an Inactive-Radio Network Temporary Identifier (I-RNTI) or a Temporary Mobile Subscriber Identity (S-TMSI).

5. The network entity of claim 2, wherein the network entity is an original serving base station of the selected UE device and the paging area is a Radio Access Network (RAN) based Notification Area (RNA), the original serving base station comprising:
a wireless transmitter configured to transmit a release message to the selected UE device to release the selected UE device from the RRC_CONNECTED to RRC_INACTIVE,
the communication interface configured to receive the neighbor list data from at least one other base station.

6. The network entity of claim 2, wherein:
the network entity is a core network and the paging area is a Tracking Area (TA);
the communication interface is configured to send a release message through an original serving base station of the selected UE device to release the selected UE device from RRC_CONNECTED to RRC_IDLE.

7. An original serving base station comprising:
a transmitter configured to transmit a release message to a selected user equipment (UE) device to release the selected UE device from Radio Resource Control (RRC)_CONNECTED to RRC_INACTIVE;
a network interface configured to receive neighbor list data from at least one other base station, the network interface further configured to receive a page notification from a core network indicating the selected UE device is to be paged;
a controller configured to evaluate the neighbor list data to determine that the neighbor list data identifies the selected UE device, the controller configured to identify, at least partially based on the neighbor list data, a subset of base stations of all the base stations in a Radio Access Network (RAN) based Notification Area (RNA), the subset including at least one base station,
the network interface configured to send a paging instruction to the at least one base station instructing the at least one base station to send a page message to the selected UE device.

8. The original serving base station of claim 7, wherein the controller is configured to determine a geographical location of the selected UE device at least partially based on the neighbor list data and to identify the at least one base station based on the geographical location.

9. The original serving base station of claim 8, wherein the neighbor list data includes one or more of the following: Global Positioning Satellite (GPS) coordinates, Global Navigation Satellite System (GNSS) coordinates, signal strength of a reference signal received at the reporting UE device, Angle of Arrival (AoA) of the reference signal, or a current cell ID of a current serving base station of the selected UE device.

10. A reporting user equipment (UE) device comprising:
a controller configured to generate a neighbor list comprising a UE identifier identifying a selected UE device, the selected UE device released from a Radio Resource Control Connected (RRC_CONNECTED) state by an original serving base station; and
a transmitter configured to transmit a neighbor list message based, at least partially, on the neighbor list to a second base station to invoke transmission of neighbor list data from the second base station to the original serving base station, the neighbor list data comprising the UE identifier and location-related information related to a geographical location of the selected UE device.

11. The reporting UE device of claim 10, further comprising:
a receiver configured to receive a sidelink discovery signal comprising the UE identifier.

12. The reporting UE device of claim 11, wherein the UE identifier includes at least one of a Layer 2 UE ID, an Inactive-Radio Network Temporary Identifier (I-RNTI) or a Temporary Mobile Subscriber Identity (S-TMSI).

13. The reporting UE device of claim 12, wherein the sidelink discovery signal transmitted from the selected UE device based on a sidelink discovery signal configuration requiring inclusion of the I-RNTI or the S-TMSI.

14. The reporting UE device of claim 13, wherein the sidelink discovery signal configuration is received at the selected UE device from the second base station.

15. The reporting UE device of claim 13, wherein the sidelink discovery signal configuration is received at the selected UE device from the original serving base station.

16. The reporting UE device of claim 10, wherein the neighbor list message further comprises an original serving cell identifier of the original serving base station.

17. The reporting UE device of claim 11, wherein
the controller is configured to measure a signal strength of the sidelink discovery signal, and
the neighbor list identifies the selected UE device when the signal strength is above a neighbor list signal strength threshold.

18. A user equipment (UE) device comprising:
a transmitter configured to transmit a sidelink discovery signal comprising at least one of a Temporary Mobile Subscriber Identity (S-TMSI) or an Inactive Radio Network Temporary Identifier (I-RNTI).

19. The UE device of claim 18, further comprising:
a receiver configured to receive a sidelink discovery signal configuration message from a serving base station, the sidelink discovery signal configuration message indicating that sidelink discovery signals will include at least one of the S-TMSI or the I-RNTI.

20. The UE device of claim 18, wherein the sidelink discovery signal comprises a current cell identifier identifying a current serving base station of the UE device.

21. The UE device of claim 18, wherein the sidelink discovery signal comprises an original cell identifier identifying an original serving base station that released the UE device from Radio Resource Control (RRC)_CONNECTED.

22. The UE device of claim 18, wherein the sidelink discovery signal comprises a location parameter indicating a geographical location of the UE device.
